(19) United States
(12) Patent Application Publication
(10) Pub. No.: US 2006/0184799 A1
(43) Pub. Date: Aug. 17, 2006

(54) Security circuit and method to secure information in a device

(75) Inventors: Yoon-Bum Seo, Seoul (KR); Myoung-Seok Kong, Suwon-si (KR); Byung-Ho Min, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/238,576

(22) Filed: Sep. 29, 2005

(30) Foreign Application Priority Data
Feb. 11, 2005 (KR) 10-2005-0011544

(51) Int. Cl. H04L 9/00

(52) U.S. Cl. 713/182

(57) ABSTRACT

A circuit and method for securing information (e.g., a product serial number or certification key) stored in non-volatile on-chip memory from unauthorized read-out or destruction. External access is prevented by writing a first n-bit security key-word into the memory. A compare circuit compares the first security key-word with a second n-bit security key-word and outputs a comparison signal that either grants or denies external access to the memory based on a predetermined compare condition. The values of each of the first and second key-word and the comparison algorithm (predetermined compare condition) may be selected to avoid any interference with external memory-testing. The predetermined compare condition may be a pre-selected one of a match and a mismatch between the first security key word and the second security key word. At least one bit of the first or second security key word may be a fuse programmable bit.

### BACKGROUND OF THE INVENTION

1. Field of the Invention

This invention relates to a circuit and method for securing on-chip memory from unauthorized access and for securing information stored in a device containing such memory. More particularly, the invention relates to security circuits and methods to prevent the read-out or loss of information such as a serial numbers or certification keys stored in a non-volatile memory in a consumer product.

2. Description of the Related Art

It is common practice among consumer product manufacturers to give each consumer product, device or appliance they sell a unique serial number, or identification number (for purposes such as identification and inventory control) and other confidential information such as certification keys. This secured information (e.g., a serial number, or a certification key) can be stored digitally in a non-volatile (external) memory, for example in EEPROM, or an on-chip memory array, or it can also be programmed, along with an embedded processor's software inside the processor's program memory array.

Consumer devices often include an embedded serial number for identification and other purposes. Typically, manufacturers assign a unique serial number to each product they sell for purposes such as identification and inventory control. If the device is returned for any reason, the manufacturer can easily identify the unit by the serial number, then the product's history can be accessed.

A serial number is typically written into a designated area of memory embedded in the consumer device. In some cases, this serial number and other confidential information must remain secret and unreadable by external devices. In other cases, it must be readable from the chip for example by a user's personal computer (PC) or by any other way of the manufacturer's choosing.

In some cases, the serial number etc. is stored in an area of memory that can be accessed by the user and so the user can inadvertently or intentionally modify the stored data. In such a case, the serial number and other information will not be properly secured and the product may not be properly identified.

Some devices include certification keys, which although they are unknown to the user, are necessary for the licensed and authorized operation of a software program or hardware apparatus. Certification keys embedded in memory are often confidential information that must remain secret.

A serial number can be composed of any number of letters and/or digits. A common method is to encode the serial number as a string of ASCII characters. The digits of a serial numbers can also be combined in pairs, to form more concise 2-digit numbers wherein two decimal digits of the serial number can be encoded into one byte. Other encoding techniques are also possible. Encryption could even be used, so that only authorized persons can decode it.

The serial number may need to meet certain requirements, some of which might be: protection against read-out; displayed along with On-Screen Display menus (OSD); and programmed at production level or updated just before shipment.

Various methods have been developed to securely store a unique serial number or certification key in a memory embedded in individual units of product. There is a method of restricting access by bonding or making physically inaccessible specific external pins of the chip or package. But, there remains a possibility of an undesirable and unauthorized read-out or destruction of confidential information through external pin operations

FIG. 1 is a block diagram illustrating a memory portion of a conventional device having relatively unsecured external access to its on-chip memory via external input/output pins 104. Referring to FIG. 1, the conventional device 100 includes a non-volatile (embedded or “on-chip”) memory (101) for storing data (e.g., a serial number, a certification key), a memory controller (102) for controlling (internal) access to the memory (101), and a test interface for facilitating external access to the (first) on-chip memory (101).

The On-chip memory (101) is a non-volatile memory. A portion of the on-chip memory stores secure information such as a serial number or a certification key. The Memory controller (102) controls (internal) access (reading writing) to and from the on-chip memory (101) by an internal processor or circuit (not shown).

The test interface (103) permits access to the on-chip memory (101) from outside in response the activation of the external test enable signal (TEST_EN) from among the external input/output pins (104). The external input/output pins (104) include a TEST_EN_PIN to receive the external test enable signal (TEST_EN), an external address pin E_ADDR_PIN to receive an external address signal (E_ADDR) for accessing the on-chip memory (101), an external control pin E_CTRL_PIN to receive an external control signal (E_CTRL), and an external data input/output pin E_DIO_PIN to receive or output a data signal (E_DIO). The TEST_EN signal is activated to read, write or change the secure information on the on-chip memory (101).

During the product production process the test enable pin (TEST_EN_PIN) is disconnected after recording confidential information, but if the chip itself is separated and the external test enable pin (TEST_EN_PIN) is accessed and biased at the activation voltage level (e.g., a logic High voltage), then external access to the contents of the on-chip memory (101) from the outside will be attainable. Thus, confidential information stored in on-chip memory (101) cannot be secured only by physically disconnecting test enable pin (TEST_EN_PIN).

There is another method for avoiding a subsequent read-out of a serial number stored on an embedded flash memory, in which the entire flash memory array is protected against read-out by storing a predetermined value (e.g., a one or a zero) in a single read-out protection bit located in a first byte (an “option byte”) of the flash memory. The serial number and other confidential information will then be somewhat protected from read-out, since the protection can generally be removed only by erasing the entire FLASH memory array. However, this method does not protect the stored data from complete erasure, and a single bit may be vulnerable to random errors induced externally (e.g., intentionally by a determined “hacker”), and includes no additional bits for potential use for error correction (ECC) nor error detection. Also, this method may interfere with external memory testing. And, in non-volatile memory types other than FLASH memory (e.g., ferroelectric RAM), erasing the entire memory array may not be the only way to change the single read-out protection bit. And, this method does not provide the product manufacturer with the flexibility of allowing an external read-out of a serial number while preventing modification (writing or destruction) of a serial number.

### SUMMARY OF THE INVENTION

In exemplary embodiments of the invention, there is provided a circuit and method for preventing reading and/or writing (read-out and/or destruction) of serial numbers or confidential information stored (hereinafter secured information) in on-chip memory, and thus preventing unauthorized read-out and destruction of confidential information after production.

Embodiments of the invention provide the manufacturer with the ability to write a security key word into the embedded memory of the product, and to thereby prevent any subsequent read-out of and/or changes to the contents of the on-chip memory (including the security key word).

A first aspect of the invention provides a device having a memory (e.g., a non-volatile memory for storing a product serial number and/or a certification key), comprising: at least one memory location in the memory for storing a first security (key) word (a first multi-bit key-word); a gated interface (e.g., including a conventional test interface) for enabling or disabling external access to the memory depending upon an access-enable signal; a comparator for comparing the first security (key) word with a second security (key) word, wherein the access enable signal is activated (e.g., set) to enable the external access to the memory in response to a predetermined compare condition. The external access to be restricted may be a read-out of data stored in the memory, or may include both reading from and writing to the memory.

The predetermined compare condition may be a pre-selected one of a match and a mismatch between the first security (key) word and the second security (key) word. In other embodiments, the first security (key) word and the second security (key) word may be correlated with each other in more complex ways, such as by encryption techniques in which first security (key) word and the second security (key) word are uniquely associated with each other in a encryption algorithm known in the related art. In other embodiments, the first security (key) word and the second security (key) word may be each other's Boolean complement. In other embodiments, at least one of the first security (key) word and the second security (key) word may comprise error correction or error detection bits.

The second security (key) word may be stored in the same memory or in a second memory, and the first memory (and the second memory) are nonvolatile memory devices (e.g., FLASH memory, or ferroelectric memory arrays).

In some embodiments, the device may further including a first register for storing the first security (key) word prior to comparing of the first and the second security (key) words. In such embodiments, at least one of the bits of the first register may be a fuse programmable bit.

In various embodiments, the (internal access to the) memory is controlled by a memory controller (in the same chip or device).

The access enable signal is an internal signal that is generated by a Boolean AND-gate and is output therefrom to the gated interface.

Another aspect of the invention provides a method of controlling access to a memory, comprising: retrieving (e.g., from the memory) a first security (key) word (first security key-word); retrieving (e.g., from the memory or from a second memory) a second security (key) word (second security key-word); comparing the second security (key) word with the first security (key) word, and generating the access enable signal based upon the compare result; and controlling (allowing or disallowing) external access (e.g., read, or read-write) to the memory depending upon an access enable signal. The access enable signal may be inactivated (e.g., reset) to disable external access to the memory upon a preset compare condition. The preset compare condition may be either a (bitwise) match or a (bitwise) mismatch between the first security (key) word and the second security (key) word.

The first security (key) word may be stored in a first nonvolatile memory, and the second security (key) word may be stored in the same memory or in a second nonvolatile memory, wherein both the first and second nonvolatile memory may be flash memory. Thus, the first and second security (key) words are stored in nonvolatile memory in the device. The entire memory of the device may be a non-volatile memory (e.g., FLASH, or FRAM).

The method may further include loading at least the first security (key) word into a register prior to comparing it with the second security (key) word. Similarly, the method may further include loading the second security (key) word into a register prior to comparing. The method may further include providing and programming a fuse to define at least one bit of the first security (key) word (e.g., while stored in the first register).

Controlling external access to the memory includes performing a logical AND operation upon at least an external (e.g., test enable) signal and the (internal) compare result. In some embodiments, controlling external access to the memory includes performing a logical AND operation an external (e.g., test enable) signal and the (internal) compare result and a data availability (compare-validity) signal (LOAD). Meanwhile, (internal) access to the memory is controlled by a memory controller.

### BRIEF DESCRIPTION OF THE DRAWINGS

The invention will become more apparent to those of ordinary skill in the art by describing, in detail, exemplary embodiments thereof with reference to the attached drawings, wherein like elements are represented by like reference numerals, and which are given by way of illustration only and thus do not limit the scope of the invention:

FIG. 1 is a block diagram illustrating a conventional device having unsecured external access to on-chip memory;

FIG. 2 is a block diagram illustrating a security circuit (200) for restricting external access to on-chip memory of a device according to a first exemplary embodiment of the invention;

FIG. 3 is a first example of the compare logic (203) of the security circuit (200) of FIG. 2;

FIG. 4 is a second example of the compare logic (203) of the security circuit (200) of FIG. 2;

FIG. 5 is a flow chart illustrating the loading of the register (301) of FIG. 3;

FIG. 6 is a circuit block diagram of the access controller (206) of FIG. 2;

FIGS. 7a, 7b and 7c are flow charts illustrating three exemplary methods of operation of the security circuit (200) of FIG. 2;

FIG. 8 is a block diagram illustrating a security circuit 800 for preventing external access to on-chip memory of a device according to a second exemplary embodiment of the invention;

FIG. 9 is a first example of the compare logic (803) of the security apparatus (800) of FIG. 8;

FIG. 10 is a second example of the compare logic (803) of the security apparatus (800) of FIG. 8;

FIG. 11 is a flow chart illustrating the loading of the registers (901, 902) in the compare logic (803) of FIG. 9; and

FIG. 12 is a flow chart illustrating an exemplary method of operation of the security circuit (800) of FIG. 8.

### DETAILED DESCRIPTION OF EXEMPLARY EMBODIMENTS OF THE INVENTION

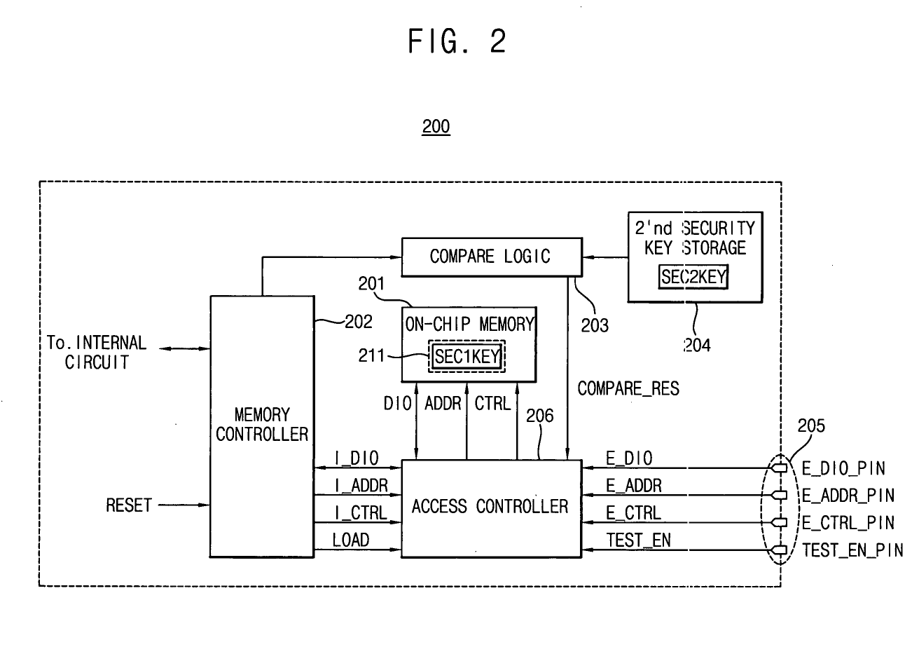

FIG. 2 is a block diagram illustrating a security circuit (200) for restricting external access to on-chip memory of a device according to a first exemplary embodiment of the invention.

Referring to FIG. 2, a security circuit (200) is comprised of a non-volatile (embedded or “on-chip”) memory (201) for storing secure data (e.g., a serial number, a certification key) and a security key-word, a memory controller (202) for controlling (internal) access to the memory (201), a second non-volatile memory for storing a second security key-word, a compare logic (203) for comparing the first and second security key words; and an access-controller for restricting external access to the (first) on-chip memory (201).

The on-chip memory (201) is preferably a non-volatile memory. The on-chip memory (201) stores secured information including a serial number or a certification key. A first security key-word SEC1KEY is written to and stored in a fixed location (211) (e.g., the first one or more bytes) of the on-chip memory (201). A serial number, a certification key and other data may be written to the on-chip memory (201) from outside, via the input/output pins (205), or from the inside, via the memory controller (202). The first security key-word SEC1KEY may be written simultaneously with the serial number, a certification key and other data or written later to the on-chip memory (201) from outside, via the input/output pins (205), at a particular value (based on the value of the second security key-word SEC2KEY) to restrict subsequent external access (reading or writing) to the on-chip memory (201) from the outside (external access).

The memory controller (202) controls (internal) access (read/write) of the on-chip memory (201). When access (reading/writing) from the outside (external access) is restricted, access to the on-chip memory (201) is available only through the memory controller (202) and is not prevented by the access controller (206). Thus a serial number stored or a certification number stored, in the on-chip memory (201) may be accessed and used (and displayed) by the internal circuit of the device (not shown).

The input/output pins (205) comprise a TEST_EN_PIN to receive an external test enable signal (TEST_EN), an E_ADDR_PIN to receive an external address signal (E_ADDR) for accessing the on-chip memory (201), an E_CTRL_PIN to receive an external control signal (E_CTRL), and a E_DIO_PIN to receive (or transmit) a data signal (E_DIO). To read, write or change the secure information in the on-chip memory (201) from the outside, the external TEST_EN signal is activated.

The access controller (206) controls (external) access to the on-chip memory (201) in response to the internal compare signal (COMPARE_RES) from the compare logic (203) and the external test enable signal (TEST_EN) from the input/output pins (205). If either one of the internal compare signal (COMPARE_RES) or the external test enable signal (TEST_EN) is inactive (e.g., low), the access controller (206) prevents access to the on-chip memory (201) via the input/output pins (205).

The compare logic (203) performs a comparison between the first security key-word SEC1KEY and the second security key-word SEC2KEY and outputs the resulting security key compare signal (COMPARE_RES).

The second security key-word storage (e.g., a second memory) (204) stores (e.g., latches) and outputs the second security key-word SEC2KEY which is to be compared in the compare logic (203) with the first security key-word SEC1KEY stored in the (first) memory (201). The key value stored in second security key-word storage (204) resides permanently in the chip (200). The second security key-word storage (204) may be comprised of a hardwired ROM (e.g., formed in silicon or metallization during chip fabrication), or an EEPROM, or a fuse bank, or a FLASH memory, or a latched ferroelectric cell circuit, or other static data output circuit that would be available immediately at power up.

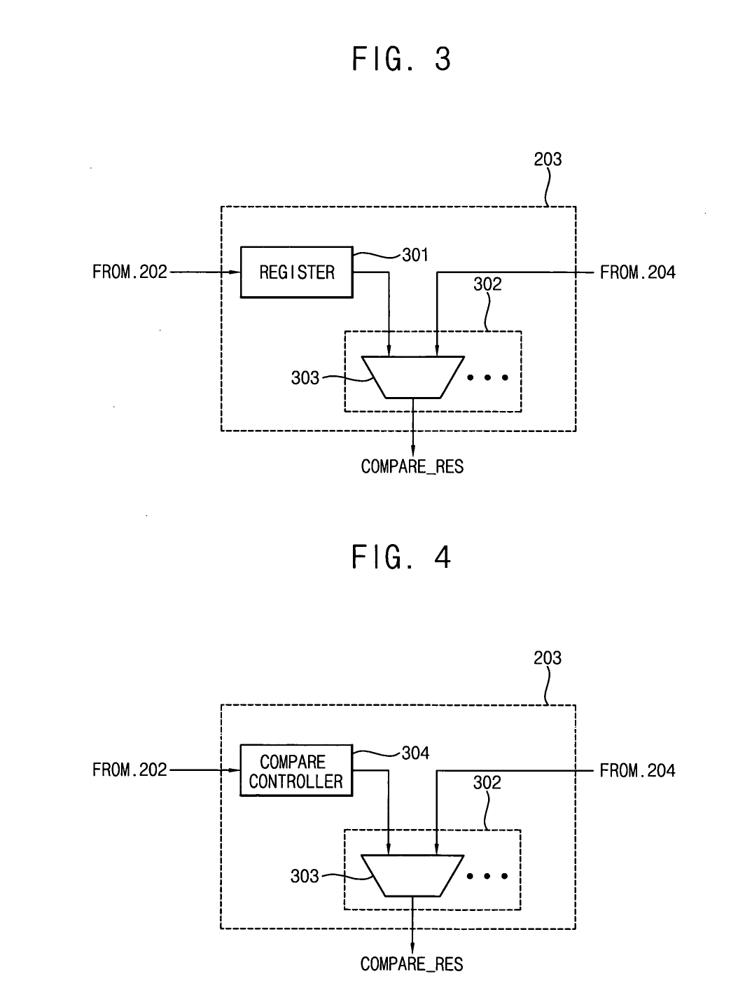

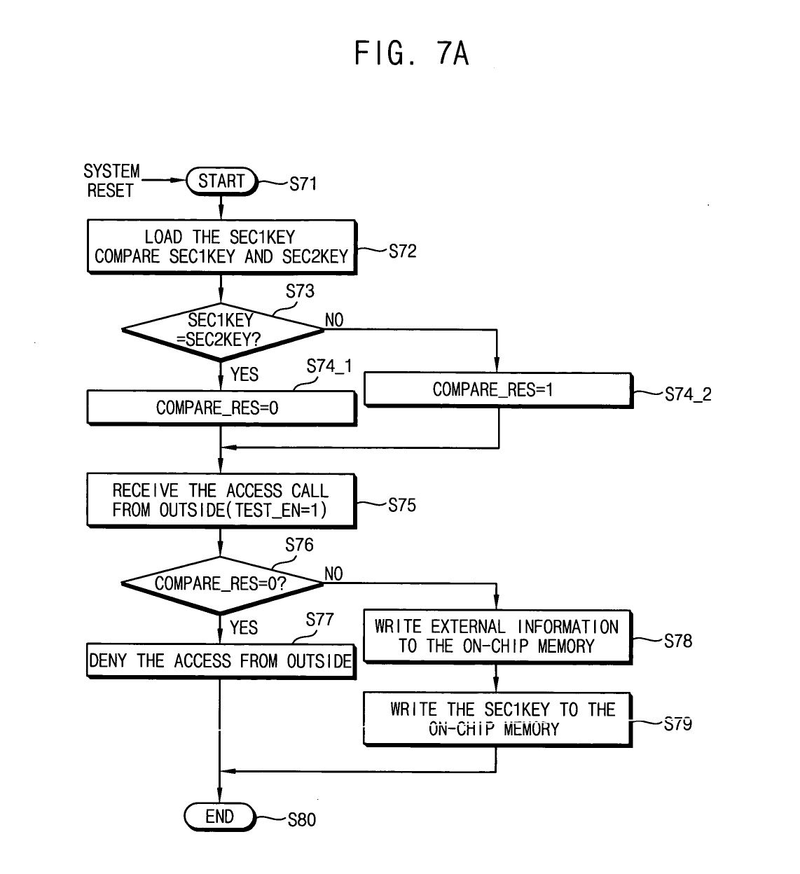

The compare logic (203) and the access controller (206) are shown in greater detail in FIGS. 3 and 6, respectively, below.

FIG. 3 is a first example of the compare logic (203) of the security circuit (200) of FIG. 2. The compare logic (203) comprises a register (301) and a compare part (302) which has at least one comparator (303). The register (301) receives the first security key word SEC1KEY from the fixed area (211) of the memory 201 via the memory controller (202). Thereafter, the security key word SEC1KEY is also stored in the register (301). The compare part (302) compares the first security key word SEC1KEY in the register (301) and the second security key word SEC2KEY in the second security key storage (204). The compare logic (203) outputs the security key compare signal (COMPARE_RES) based upon the comparison. For example, in some exemplary embodiments of the invention, if the stored value of the first security key word SEC1KEY matches (i.e., is bitwise the same as) the second security key word SEC2KEY, the security key compare signal (COMPARE_RES) will be inactive (e.g., low), thus preventing external access to the memory (201). Conversely, in such embodiments, if the stored value of the first security key word SEC1KEY mismatches (i.e., is bitwise the not same as) the second security key word SEC2KEY, the security key compare signal (COMPARE_RES) will be active (e.g., high), thus allowing external access to the memory (201).

In other exemplary embodiments of the invention, if the value of the first security key word SEC1KEY mismatches (i.e., is bitwise not the same as) the second security key word SEC2KEY, the security key compare signal (COMPARE_RES) will be inactive (e.g., low), thus preventing external access to the memory (201). Conversely, in such other embodiments, if the stored value of the first security key word SEC1KEY matches (i.e., is bitwise the same as) the second security key word SEC2KEY, the security key compare signal (COMPARE_RES) will be inactive (e.g., low), thus allowing external access to the memory (201).

In still other exemplary embodiments of the invention, if the value of the first security key word SEC1KEY is the Boolean complement of (i.e., is bitwise the opposite of) the second security key word SEC2KEY, the security key compare signal (COMPARE_RES) will be inactive (e.g., low), thus preventing external access to the memory (201). Conversely, in such other embodiments, if the stored value of the first security key word SEC1KEY is not the Boolean complement of the second security key word SEC2KEY, the security key compare signal (COMPARE_RES) will be active (e.g., high), thus allowing external access to the memory (201).

Persons skilled in the art will recognize that there are many other mathematical relationships which may be preselected and preset by a designer and detected, by a correspondingly designed compare part (302), between a first security key word SEC1KEY and the second security key word SEC2KEY. The value of the second security key word SEC2KEY (and thus, the associated value of the first security key word SEC1KEY) may be readily selected by persons skilled in the art so as to avoid having a bit pattern likely to be used in any memory testing algorithm, thus avoiding any interference with external memory testing, and allowing even the fixed location (211) of the memory used for storing the first security key word SEC1KEY and adjacent locations to be thoroughly memory-tested.

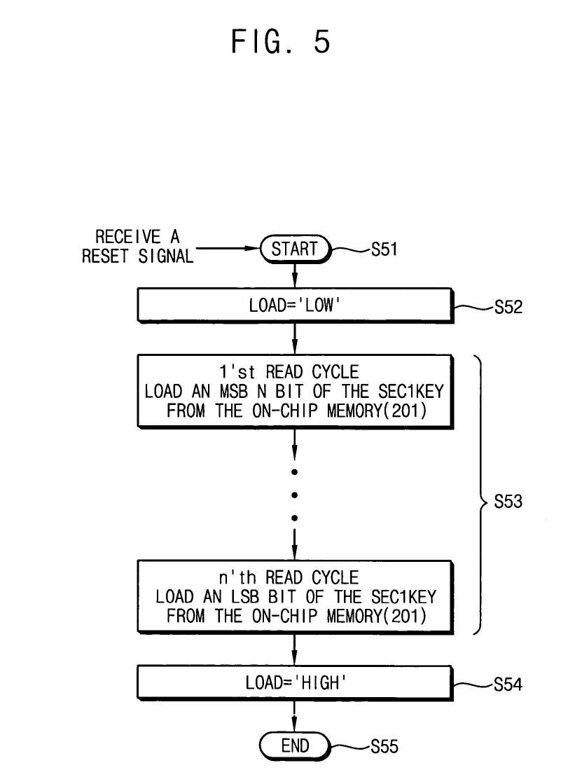

FIG. 4 is a second example of the compare logic (203) of the security circuit (200) of FIG. 2. The compare logic (203) comprises a compare part (302) which has at least one comparator (303) and a compare controller (304). The compare controller (304) reads the first security key word SEC1KEY from the on-chip memory (201) synchronously and transfers both keywords to the comparator (303) of the compare part (302). The compare part (302) compares the first security key word SEC1KEY from the fixed area (211) of the memory (201) and second security key word SEC2KEY from the second storage key storage (204).

The compare logic (203) outputs the security key compare signal (COMPARE_RES) based on the comparison, just as in connection with the description of FIG. 3.

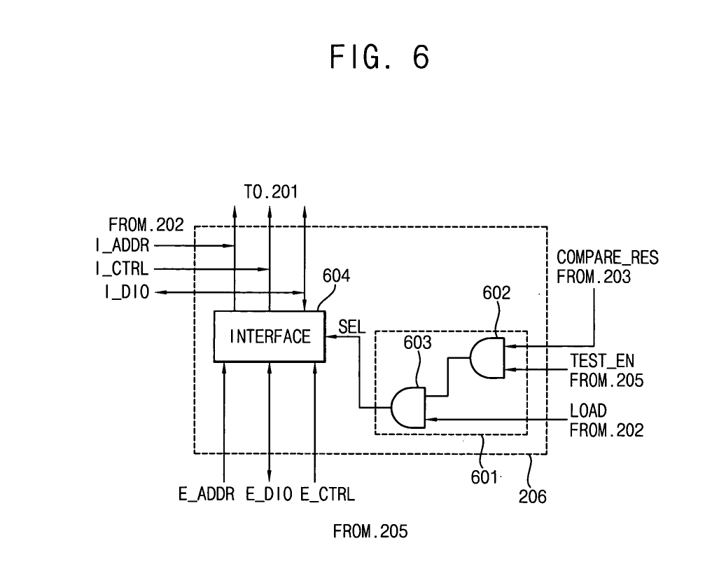

FIG. 5 is a flow chart illustrating the loading of the register (301) of FIG. 3. At the start (S51), the memory controller receives a reset signal (e.g., when system reset or power on occurs). And next, (S52), the memory controller (202 of FIG. 2) that receives the system reset signal inactivates (initializes) the load completion signal (LOAD), (e.g., by initializing it “Low”). The LOAD signal is a data-availability flag for the Access Controller (206) to indicate when the security key compare signal (COMPARE_RES) is valid based on valid stored values. The LOAD signal is used as a decision signal by the access controller (206) and prevents the access from the outside until a valid security key compare signal (COMPARE_RES) is available. Next, the loading of the first security key word SEC1KEY into the register (301) begins (S53). The n-bits (n is an integer greater than one) of the first security key word SEC1KEY are loaded (e.g., in serial fashion) from the on-chip memory (201) into the register (301) during n read cycles (S53). Once all the n bits (e.g., from most significant bit MSB to least significant bit LSB) of the first security key word SEC1KEY are loaded into the register (301), the loading is completed, and the LOAD signal is made active (e.g., “high”) (S54) indicating the availability of the first security key word SEC1KEY to the compare part (302) of the compare logic (203).

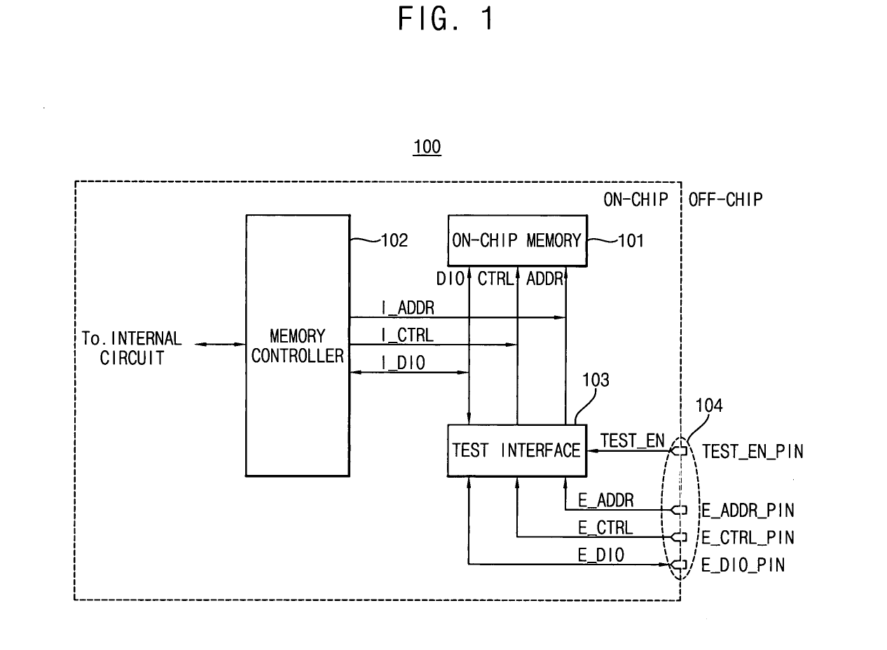

FIG. 6 is a circuit block diagram of the access controller (206) of FIG. 2. The access controller (206) comprises a logic operator (combinatorial logic circuit 601) and an interface (604). The interface (604) may be the same as the test interface 103 of FIG. 1, and is a gated interface. The signals E_ADDR_PIN, E_CTRL_PIN, and E_DIO_PIN are gated (e.g., passed or blocked) by the gated interface (604) based on the status of the access selection signal (SEL).

The access selection signal (SEL) is output to the by the logic operator (601) based on the logical combination of external signal TEST_EN from the input/output pins (205), and the internal security key compare signal (COMPARE_RES) from the compare part (302) of the compare logic (203), and the load completion signal (LOAD) from the memory controller (202).

The logic operator (601) comprises two cascaded two-input AND-gates (602, 603) forming one three-input AND-gate (logic operator 601). The first AND-gate (602) performs a logical AND operation upon the security key compare signal (COMPARE_RES, which is the compare result of the SEC1KEY and SEC2KEY) and the external signal TEST_EN from the input/output pins (205). The second AND-gate (603) performs a logical AND operation upon the output from the first AND-gate (602) and the load completion signal (LOAD) from the memory controller (202).

The logic operator (601, e.g., a three-input AND-gate) outputs the logical combination (of external signal TEST_EN, and the internal security key compare signal (COMPARE_RES), and the load completion signal (LOAD)) as an access selection signal (SEL) which grants (1) or withholds (0) the external access to the on-chip memory (201) from outside, according to Truth Table. 1.

TABLE 1
Truth

| | | | | Access Permission |
|---|---|---|---|---|
| Case | LOAD | COMPARE_RES | TEST_EN | (SEL) |
| 1 | 0 | 0 | 0 | 0 |
| 2 | 0 | 0 | 1 | 0 |
| 3 | 0 | 1 | 0 | 0 |
| 4 | 0 | 1 | 1 | 0 |
| 5 | 1 | 0 | 0 | 0 |
| 6 | 1 | 0 | 1 | 0 |
| 7 | 1 | 1 | 0 | 0 |
| 8 | 1 | 1 | 1 | 1 |

As is illustrated in FIG. 1, the access selection signal (SEL) is active (e.g., high, 1) and grants external access to the on-chip memory (201) from outside via the gated interface (604), if and only if all three of the external signal TEST_EN, and the internal security key compare signal (COMPARE_RES), and the load completion signal (LOAD) are active (e.g., high, 1). Thus, if the security key compare signal (COMPARE_RES) is inactive (e.g., Low, 0) the secured data (e.g., serial number or certification keys) stored in the memory (201) will be secured as against external access even if the external pin TEST_EN_PIN (205) is physically accessible.

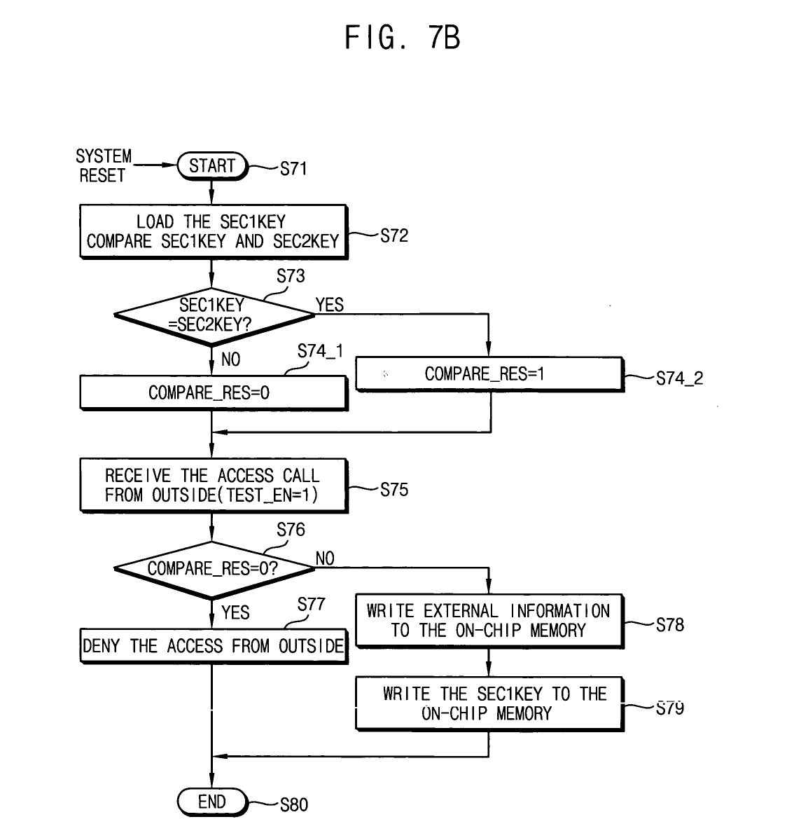

FIGS. 7a, 7b and 7c are flow charts illustrating three exemplary methods of operation of the security circuit (200) of FIG. 2. FIGS. 7a, 7b and 7c and the exemplary methods of operation that they depict are the same except in step S73, which illustrates the alternative comparison operations performed by three alternative implementations of the compare part (302 of FIGS. 3 and 4). Thus, the steps of FIGS. 7a, 7b and 7c will be hereinafter described together as being the same except for step S73, which is implemented differently in each figure.

In the methods of FIGS. 7a, 7b and 7c, S71, the operation of the security circuit (200 of FIG. 2) starts upon a system reset signal or power on signal (S71). Next, in step S72 of the methods of FIGS. 7a, 7b and 7c, the first security key word SEC1KEY is loaded into the register (301). And next in step S73 of each of the methods of FIGS. 7a, 7b and 7c the first security key word SEC1KEY is compared with the second security key word SEC2KEY, however the precise nature of the comparison is different in each of the methods of FIGS. 7a, 7b and 7c.

In step S73 of the methods of FIGS. 7a and 7b, the first security key word SEC1KEY is compared with the second security key word SEC2KEY to determine whether the first security key word SEC1KEY matches (i.e., is bitwise equal to; the same as) or mismatches (i.e., is bitwise not equal to; not the same as) the second security key word SEC2KEY.

In the method of FIG. 7a: if the first security key word SEC1KEY matches (i.e., is bitwise equal to; the same as) the second security key word SEC2KEY, then alternative step S74_1 is performed and the security key compare signal (COMPARE_RES) output by the compare part (302 of FIG. 3) is made inactive (e.g., Low, 0) so that external access to the memory (201) will be prevented; and if the first security key word SEC1KEY mismatches (i.e., is not bitwise equal to; not the same as) the second security key word SEC2KEY, then alternative step S74_2 is performed and the security key compare signal (COMPARE_RES) output by the compare part (302 of FIG. 3) is made active (e.g., High, 1) so that external access to the memory (201) will be allowed.

In the method of FIG. 7b, the reverse mode of the compare operation S73 of FIG. 7a is performed: if the first security key word SEC1KEY matches (i.e., is bitwise equal to; the same as) the second security key word SEC2KEY, then alternative step S74_2 is performed and the security key compare signal (COMPARE_RES) output by the compare part (302 of FIG. 3) is made active (e.g., High, 1) so that external access to the memory (201) will be allowed; and if the first security key word SEC1KEY mismatches (i.e., is not bitwise equal to; not the same as) the second security key word SEC2KEY, then alternative step S74_1 is performed and the security key compare signal (COMPARE_RES) output by the compare part (302 of FIG. 3) is made inactive (e.g., Low, 0) so that external access to the memory (201) will be prevented.

In step S73 of the method of FIG. 7c, the first security key word SEC1KEY is compared with the second security key word SEC2KEY to determine whether the first security key word SEC1KEY is the logical (bitwise) complement of the second security key word SEC2KEY (as denoted by the negative sign). In the method of FIG. 7c: if the first security key word SEC1KEY is the logical complement of the second security key word SEC2KEY, then alternative step S74_1 is performed and the security key compare signal (COMPARE_RES) output by the compare part (302 of FIG. 3) is made inactive (e.g., Low, 0) so that external access to the memory (201) will be prevented; and if the first security key word SEC1KEY is the logical complement of the second security key word SEC2KEY, then alternative step S74_2 is performed and the security key compare signal (COMPARE_RES) output by the compare part (302 of FIG. 3) is made active (e.g., High, 1) so that external access to the memory (201) will be allowed.

Next, in step S75 of the methods of FIGS. 7a, 7b and 7c, an active external signal TEST_EN is received via the external pin TEST_EN_PIN (and combined with the internal security key compare signal (COMPARE_RES). In step S76 of the methods of FIGS. 7a, 7b and 7c; when an active external signal TEST_EN is combined with an inactive internal security key compare signal (COMPARE_RES=0), alternative step S77 is performed and access from the outside (external access) is prevented (denied); and when an active external signal TEST_EN is combined with an active internal security key compare signal (COMPARE_RES=1), access from the outside (external access) is allowed (granted) (S78) until alternative step S79 is performed.

Thus, if an active external signal TEST_EN is combined with an active internal security key compare signal (COMPARE_RES=1), then in step S78 an external access may read, write or verify the secure information in on-chip memory (201) and, optionally, in step S79 future external access may be immediately prevented by writing an appropriate value of first security key word SEC1KEY into the fixed location (211) of the memory (201). If step S79 is performed such that external access is prevented by writing an appropriate value of first security key word SEC1KEY into the fixed location (211) of the memory (201), then any subsequently attempted external access S75 will result in the external access being denied S77.

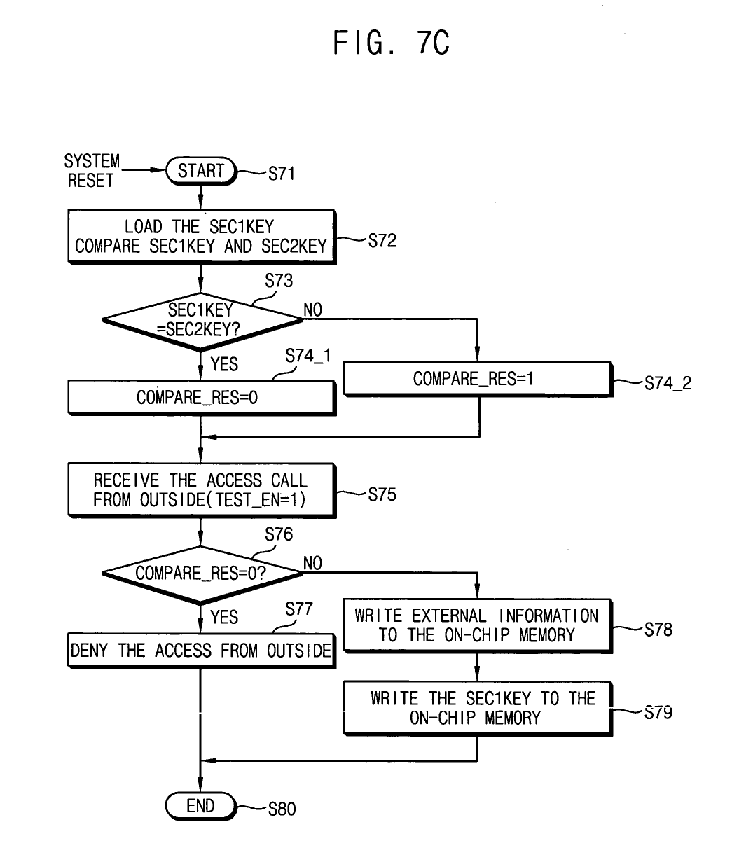

FIG. 8 is a block diagram illustrating a security circuit 800 for preventing external access to on-chip memory of a device according to a second exemplary embodiment of the invention.

The on-chip memory (801) is a non-volatile memory for storing secure information (e.g., a serial number, or a certification key) and also for storing both of a first security key-word SEC1KEY and a second security key-word SEC2KEY. The two security key-words SEC1KEY and SEC2KEY are stored in a fixed location (811) of the on-chip memory (801), for restricting access to the on-chip memory (801) from the outside.

The input/output pins (205), and the access controller (206), of FIG. 8 and their associated signals (e.g., LOAD, COMPARE_RES, TEST_EN, E_ADDR, E_CTRL, E_DIO) are and function the same as in FIG. 2.

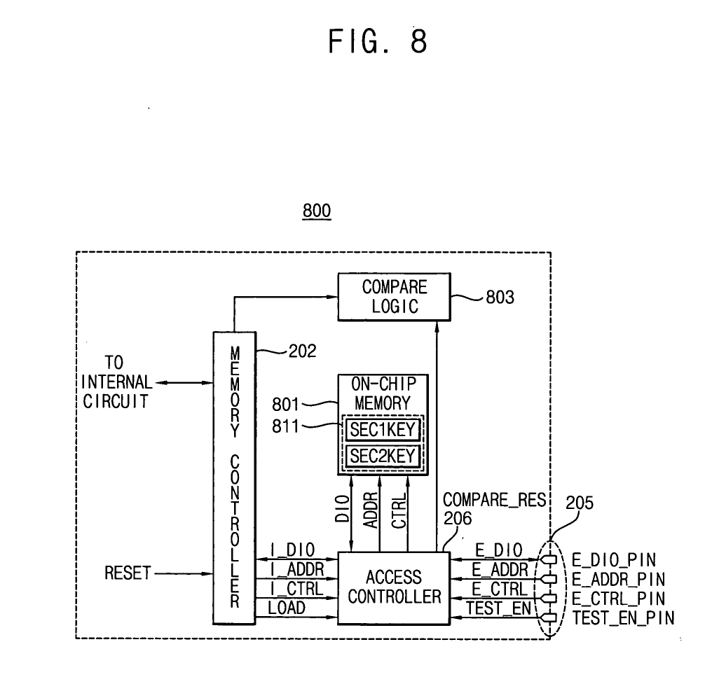

The memory controller (802) of FIG. 8 operates the same as the memory controller (202) in FIG. 2 except that it outputs both the first and second security key words to (registers 901 and 902 in) the compare logic 803 and outputs the LOAD signal upon the completion of loading both registers (901 and 902) in the compare logic 803, as is illustrated in greater detail in FIGS. 9, 10, and 11.

The compare logic (803) compares the first security key-word SEC1KEY and the second security key-word SEC2KEY and outputs a resulting security key compare signal (COMPARE_RES) in the same manner and potentially using one the same variety of comparison methods as the compare logic (203) of FIG. 2.

FIG. 9 is a first example of the compare logic (803) of the security apparatus (800) of FIG. 8.

The compare logic (803) comprises two registers (901, 902) and a compare part (303) that has at least one comparator (304). The registers (901 and 902) receive and store the first security key-word SEC1KEY and the second security key-word SEC2KEY from the fixed area (811). The compare part (303) compares the first security key-word SEC1KEY and the second security key-word SEC2KEY stored (e.g., latched) in the registers (901 and 902). The compare part (303) and the comparator (304) of FIG. 9 has the same form and functions as the compare part 303 and comparator (304) of FIG. 3. Thus, the compare logic (803) outputs the resulting security key compare signal (COMPARE_RES) based upon a comparison of the first security key-word SEC1KEY and the second security key-word SEC2KEY.

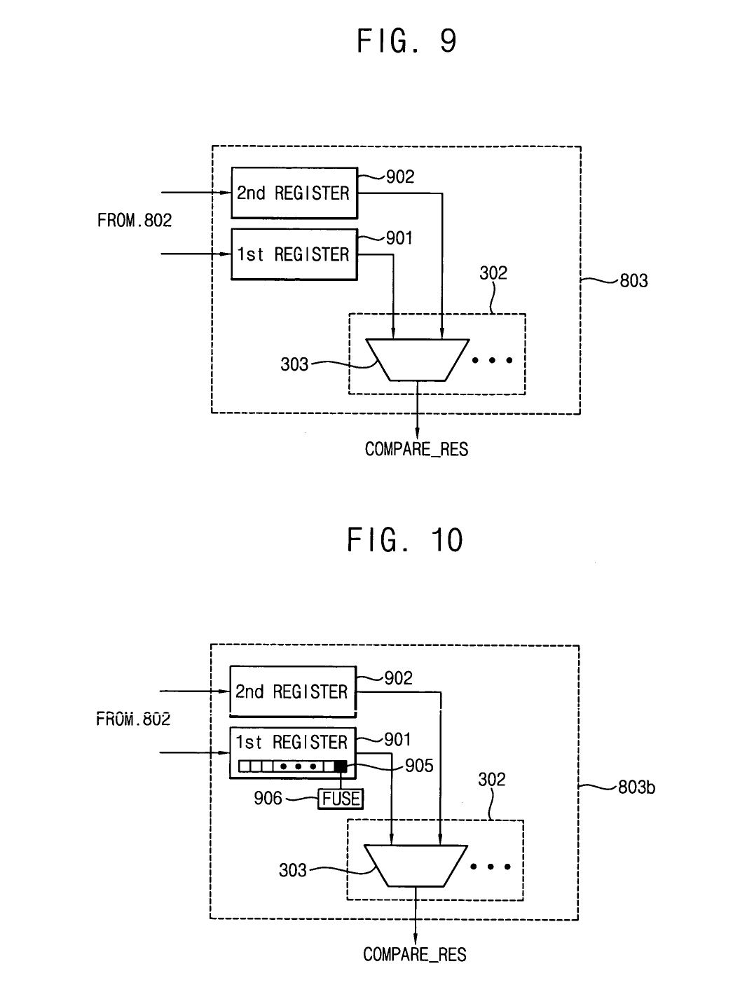

FIG. 10 is a second example of the compare logic (803b) of the security apparatus (800) of FIG. 8. The compare logic (803b) from FIG. 10 comprises at least one (fuse programmable) bit (905) and an equal number (e.g., at least one) of programmable fuses (e.g., a laser-programmable fuse 906). The programmable fuse (906) is operatively connected in a conventional manner to the at least one (fuse programmable) bit (905) of the first register (901). The value of the fuse programmable bit (905) of the first register is operatively controlled by the fuse (906) and can hold a programmed value (1 or 0) depending upon whether the fuse (906) is blown or unblown. When the fuse (906) is blown, at least one bit of the first security key-word is fixed in such a manner that the comparison between the SEC1KEY and the SEC2KEY result in a security key compare signal (COMPARE_RES) having an inactive (e.g., low, 0) value, thus preventing external access to the on-chip memory (801 of FIG. 8), so that the secure information (e.g., including a serial number or a certification key) is secured. Before the fuse (906) is blown, at least one bit of the first security key-word is fixed in such a manner that the comparison between the SEC1KEY and the SEC2KEY result in a security key compare signal (COMPARE_RES) having an active (e.g., high, 1) value, thus allowing further external access to the on-chip memory (801 of FIG. 8). The fuse (906) may be employed as a fail-safe to avoid premature lock-out from external access of the memory 801.

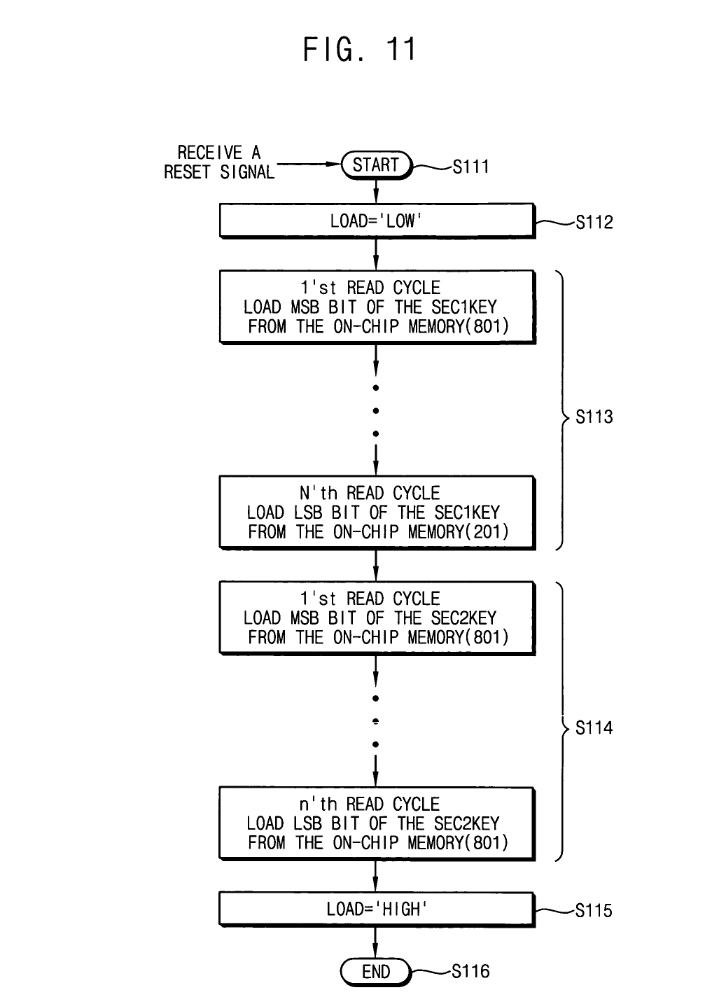

FIG. 11 is a flow chart illustrating the loading of the two registers (901, 902) in the compare logic (803 and 803b) of FIGS. 9 and 10. At the start (S111), the memory controller receives a reset signal (e.g., when system reset or power on occurs). And next, (S112), the memory controller (802 of FIG. 8) that receives the system reset signal inactivates (initializes) the load completion signal (LOAD), (e.g., by initializing it “Low”). The LOAD signal is a data-availability flag for the Access Controller (206 of FIG. 8) to indicate when the security key compare signal (COMPARE_RES) is valid based on valid stored values. The LOAD signal is used a decision signal by the access controller (206) and prevents the access from the outside until a valid security key compare signal (COMPARE_RES) is available. Next, the loading of the first security key word SEC1KEY into the first register (901 of FIGS. 9 and 10) begins (S113). The n-bits (n is an integer greater than one) of the first security key word SEC1KEY are loaded (e.g., in serial fashion) from the on-chip memory (801) into the first register (901) during n read cycles (S113). Once all the n bits (e.g., from most significant bit MSB to least significant bit LSB) of the first security key word SEC1KEY are loaded into the first register (901) (S113), the loading of the second security key word SEC2KEY into the second register (902) is begun (S114). The n-bits (n is an integer greater than one) of the second security key word SEC1KEY are loaded (e.g., in serial fashion) from the on-chip memory (801) into the second register (902) during n read cycles (S114). Once all the n bits (e.g., from most significant bit MSB to least significant bit LSB) of the second security key word SEC2KEY are loaded into the second register (902) (S114), the loading is completed, and the LOAD signal is made active (e.g., “high”) (S115) indicating the availability of the first and second security key words SEC1KEY and SEC2KEY to the compare part (302) of the compare logic (803).

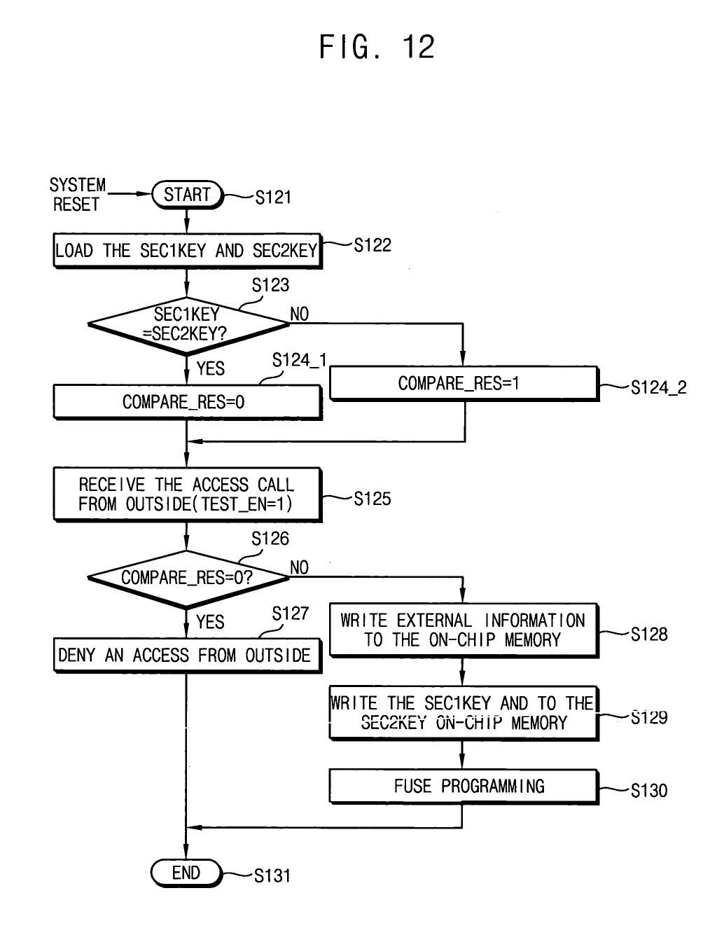

FIG. 12 is a flow chart illustrating an exemplary method of operation of the security circuit (800) of FIG. 8. FIG. 12 depicts an exemplary method of operation and other methods are possible, particularly those in which the precise comparison or branching performed in step S123 is varied. In the method of FIG. 12, the operation of the security circuit (800 of FIG. 8) starts upon a system reset signal or power on signal (S121). Next, in step S122 the first security key word SEC1KEY is loaded into the first register (901), the second security key word SEC2KEY is loaded into the second register (901), and the LOAD signal becomes active (see steps S113, S114 and S115 of FIG. 11).

Next, S123, the first security key word SEC1KEY is compared with the second security key word SEC2KEY. In step S123 of FIG. 12 the first security key word SEC1KEY is compared with the second security key word SEC2KEY to determine whether the first security key word SEC1KEY matches (i.e., is bitwise equal to; the same as) or mismatches (i.e., is bitwise not equal to; not the same as) the second security key word SEC2KEY.

In the exemplary method of FIG. 12: if the first security key word SEC1KEY matches (i.e., is bitwise equal to; the same as) the second security key word SEC2KEY, then alternative step S124_1 is performed and the security key compare signal (COMPARE_RES) output by the compare part (302 of FIG. 8) is made inactive (e.g., Low, 0) so that external access to the memory (801) will be prevented (denied); and if the first security key word SEC1KEY mismatches (i.e., is not bitwise equal to; not the same as) the second security key word SEC2KEY, then alternative step S124_2 is performed and the security key compare signal (COMPARE_RES) output by the compare part (302 of FIG. 8) is made active (e.g., High, 1) so that external access to the memory (801) will be allowed (granted).

Next, in step S125, an active external access-request signal TEST_EN is received via the external pin TEST_EN_PIN (and combined with the internal security key compare signal (COMPARE_RES). In step S126; when an active external signal TEST_EN is combined with an inactive internal security key compare signal (COMPARE_RES=0), alternative step S127 is performed and access from the outside (external access) is prevented (denied); and when an active external signal TEST_EN is combined with an active internal security key compare signal (COMPARE_RES=1), access from the outside (external access) is allowed (granted) (S128) until alternative steps S129 and S130 are performed.

Thus, if an active external signal TEST_EN is combined with an active internal security key compare signal (COMPARE_RES=1), then in step S128 an external access may read, write or verify the secure information in on-chip memory (801) and, optionally by performing steps S129 and S130 future external access may be immediately prevented by writing an appropriate values of first security key word SEC1KEY and second security key word SEC2KEY into the fixed location (811) of the memory (801). In step S130, a fuse (906) is programmed so that the security key word SEC1KEY stored in the first register (901 of FIG. 10) has its terminal value for preventing external access to the memory 801.

If steps S129 and S130 are performed such that external access to the memory 801 is prevented, by writing an appropriate value of first security key word SEC1KEY into the fixed location (811) of the memory (801) and into the fuse programmable bit(s) (906) in the first register (901 of FIG. 10), then any subsequently attempted external access S125 will result in the external access being denied S127.

Having thus described exemplary embodiments of the invention, it is to be understood that the invention defined by the appended claims is not to be limited by particular examples and details set forth in the above description as many apparent variations thereof are possible without departing from the spirit or scope thereof as hereinafter claimed.

What is claimed is:

1. A device having a memory, comprising:
at least one memory location in the memory for storing a first security word;
a gated interface for enabling or disabling external access to the memory depending upon an access-enable signal; and
a comparator for comparing the first security word with a second security word,
wherein the access enable signal is activated to enable the external access to the memory in response to a predetermined compare condition.

2. The device of claim 1, wherein the predetermined compare condition is a match between the first security word and the second security word.

3. The device of claim 1, wherein the predetermined compare condition is a mismatch between the first security word and the second security word.

4. The device of claim 1, wherein the external access is a read-out of data stored in the memory.

5. The device of claim 1, wherein the external access includes a reading from and writing to the memory.

6. The device of claim 1, wherein the second security word is stored in a second memory and the first memory and the second memory are nonvolatile memory devices.

7. The device of claim 6, wherein at least one of the first and the second memories is a flash memory.

8. The device of claim 1, wherein the second security word is stored in another location in the memory.

9. The device of claim 8, wherein the memory is a flash memory.

10. The device of claim 1, further including a first register for storing the first security word prior to comparing of the first and the second security words.

11. The device of claim 10, wherein at least one of the bits of the first register is a fuse programmable bit.

12. The device of claim 1, wherein the memory is controlled by a memory controller.

13. The device of claim 1, wherein the access enable signal is output to the gated interface by a Boolean AND-gate.

14. A method of controlling access to a memory, comprising:
retrieving a first security word;
retrieving a second security word;
controlling external access to the memory depending upon an access enable signal; and
comparing the second security word with the first security word, and generating the access enable signal based upon the compare result.

15. The method of claim 14, wherein the access enable signal is inactivated to disable external access to the memory upon a preset compare condition.

16. The method of claim 14, wherein the preset compare condition is a match between the first security word and the second security word.

17. The method of claim 14, wherein the preset compare condition is a mismatch between the first security word and the second security word.

18. The method of claim 14, wherein the first security word is stored in a first nonvolatile memory, and the security word is stored in a second nonvolatile memory.

19. The method of claim 18, wherein the first and second nonvolatile memory is a flash memory.

20. The method of claim 14, wherein the first and second security words are stored in a nonvolatile memory.

21. The method of claim 20, wherein the memory is a non-volatile memory.

22. The method of claim 14, further including loading at least the first security word into a register prior to comparing.

23. The method of claim 22, further including loading the second security word into a register prior to comparing.

24. The method of claim 22, further including programming a fuse to define at least one bit of the first security word in the register.

25. The method of claim 14, wherein internal access to the memory is controlled by a memory controller.

26. The method of claim 14, wherein the step of controlling external access to the memory includes performing a logical AND operation upon at least an external signal and the compare result.
